(19) United States
(12) Patent Application Publication
(10) Pub. No.: US 2025/0376052 A1
(43) Pub. Date: Dec. 11, 2025

(54) CHARGE DISPENSER SYSTEM

(71) Applicant: Caterpillar Inc., Peoria, IL (US)

(72) Inventors: Dustin Craig Selvey, Fureka, IL (US); Martin Castonguay, Blainville (CA); Samuel Charbonneau, Mirabel (CA); Kea Voa Chin, Washington, IL (US); Patrick Levesque, Vaudreuil-Dorion (CA); Patrick Racette, Sainte-Sophie (CA); Sadiq Mohammed, Chennal (IN)

(73) Assignee: Caterpillar Inc., Peoria, IL (US)

(21) Appl. No.: 18/737,677

(22) Filed: Jun. 7, 2024

(51) Int. Cl. B60L 53/16; B60L 53/30; B60L 53/68; B60L 58/12

(52) U.S. Cl. CPC B60L 53/16; B60L 53/305; B60L 53/68; B60L 58/12

(57) ABSTRACT

A charge dispenser device to charge battery electric machines (BEMs) includes multiple charger input receptacles to receive electrical energy from multiple charger devices; a cable connector configured to connect to a charging cable, wherein the charging cable is connectable to the BEM; and a dispenser controller. The dispenser controller is configured to receive an indication from a fleet controller of a fleet management unit to start a charging session with the BEM; determine when the BEM is connected for charging; receive charging information for the BEM; activate a multiple number of charger devices for the charge dispenser to receive charging energy from the charger devices in parallel, and deliver the charging energy to the BEM during the charging session; change the number of charger devices activated during the charging session; and send an indication to the fleet controller when charging of the BEM is complete.

### TECHNICAL FIELD

This document relates to electric powered work machines and in particular to a Megawatt class charge dispenser system for charging the energy source of battery electric machines.

### BACKGROUND

Powering a large moving work machine (e.g., a wheel loader, a mining truck, etc.) with one or more electric motors requires a large mobile electric energy source that can provide current of thousands of Amperes (Amps). An example of a mobile energy source is a battery system containing multiple strings of high-capacity batteries. The batteries in each string are connected in series, and the strings of batteries are connected in parallel to provide the high output power needed by the electric work machines. The mobile energy source needs to be recharged when the energy source nears depletion. Different battery electric machines may have different power needs and charging needs.

### SUMMARY OF THE INVENTION

Electric powered large moving work machines use large capacity battery systems that need charging, and it is desirable to provide the charging at a remote job site. However, the machines at the job site may have different charging needs. It would be advantageous for a single charging system to meet the different charging needs of the different types of machines. An example charging system includes a charge dispenser and multiple chargers. The system is modular in that multiple chargers can be connected to the one dispenser to provide flexibility in meeting the charging needs at the job site.

An example charge dispenser device includes multiple charger input receptacles to receive electrical energy from multiple charger devices that are each configured to provide energy to charge a battery electric machine (BEM); a cable connector configured to connect to a charging cable that is connectable to the BEM; and a dispenser controller. The dispenser controller is configured to receive an indication from a fleet controller of a fleet management unit to start a charging session with the BEM; determine when the BEM is connected for charging; receive charging information for charging the BEM; activate a multiple number of charger devices for the charge dispenser to receive charging energy from the charger devices in parallel, and deliver the charging energy to the BEM during the charging session; change the number of charger devices activated during the charging session; and send an indication to the fleet controller when charging of the BEM is complete.

An example method of operating a charging system for a non-road BEM includes initiating a charge dispenser device of the charging system to a standby state; detecting, by the charge dispenser device, a connected state in which the charge dispenser device is connected to the BEM; entering, by the charge dispenser device, a charging state in which the dispenser activates a multiple number of charger devices in parallel to an onboard state to provide charge at an output of the dispenser; changing, by the charge dispenser device, the number of charger devices activated in parallel and providing charge during the charging state; detecting, by the charge dispenser device, that charging of the BEM is complete; sending an indication to another device to disconnect the BEM from the dispenser in response to detecting the charging is complete; and returning to the standby state when detecting disconnect of the BEM.

### BRIEF DESCRIPTION OF THE DRAWINGS

FIG. 1 is an elevation view depicting an example work machine in accordance with this disclosure.

FIG. 2 is a diagram of an example charging system for battery electric machines in accordance with this disclosure.

FIG. 3 is a block diagram of an example of portions of a charge dispenser in accordance with this disclosure.

FIG. 4 is a diagram of an example of communication networks for charger devices and a charge dispenser of a charging system in accordance with this disclosure.

FIG. 5 is an example of a state diagram of operation of a charge dispenser in accordance with this disclosure.

FIG. 6 is a flow diagram of an example of a method of operating a charge dispenser in accordance with this disclosure.

### DETAILED DESCRIPTION

Examples according to this disclosure are directed to methods and devices that improve charging of a rechargeable energy source of an electric work machine.

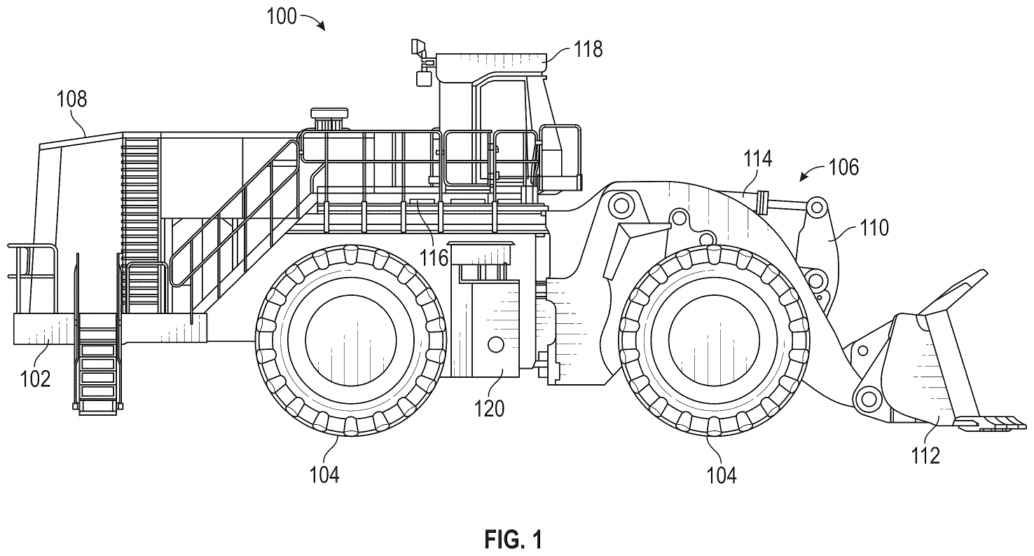

FIG. 1 depicts an example machine 100 in accordance with this disclosure. In FIG. 1, machine 100 includes frame 102, wheels 104, implement 106, and a speed control system implemented in one or more on-board electronic devices like, for example, an electronic control unit or ECU. Example machine 100 is a wheel loader. In other examples, however, the machine may be other types of machines related to various industries, including, as examples, construction, agriculture, forestry, transportation, material handling, waste management, marine, stationary power, and so on. Accordingly, although some examples are described with reference to a wheel loader machine, examples according to this disclosure are also applicable to other types of machines including graders, scrapers, dozers, excavators, compactors, material haulers like dump trucks, marine vessels, locomotives, along with other example machine types.

Machine 100 includes frame 102 mounted on four wheels 104, although, in other examples, the machine could have more than four wheels. Frame 102 is configured to support and/or mount one or more components of machine 100. For example, machine 100 includes enclosure 108 coupled to frame 102. Enclosure 108 can house, among other components, an electric motor to propel the machine over various terrain via wheels 104. In some examples, multiple electric motors are included in multiple enclosures at multiple locations of the machine 100.

Machine 100 includes implement 106 coupled to the frame 102 through linkage assembly 110, which is configured to be actuated to articulate bucket 112 of implement 106. Bucket 112 of implement 106 may be configured to transfer material such as, soil or debris, from one location to another. Linkage assembly 110 can include one or more cylinders 114 configured to be actuated hydraulically or pneumatically, for example, to articulate bucket 112. For example, linkage assembly 110 can be actuated by cylinders 114 to raise and lower and/or rotate bucket 112 relative to frame 102 of machine 100.

Platform 116 is coupled to frame 102 and provides access to various locations on machine 100 for operational and/or maintenance purposes. Machine 100 also includes an operator cabin 118, which can be open or enclosed and may be accessed via platform 116. Operator cabin 118 may include one or more control devices (not shown) such as, a joystick, a steering wheel, pedals, levers, buttons, switches, among other examples. The control devices are configured to enable the operator to control machine 100 and/or the implement 106. Operator cabin 118 may also include an operator interface such as, a display device, a sound source, a light source, or a combination thereof.

Machine 100 can be used in a variety of industrial, construction, commercial or other applications. Machine 100 can be operated by an operator in operator cabin 118. The operator can, for example, drive machine 100 to and from various locations on a work site and can also pick up and deposit loads of material using bucket 112 of implement 106. By further way of example, both operation by a remotely located operator and autonomous or robotic operation are contemplated. Machine 100 can be used to excavate a portion of a work site by actuating cylinders 114 to articulate bucket 112 via linkage assembly 110 to dig into and remove dirt, rock, sand, etc. from a portion of the work site and deposit this load in another location. Machine 100 can include a battery compartment connected to frame 102 and including a battery system 120. Battery system 120 is electrically coupled to the one or more electric motors of the battery electric machine (BEM) 100.

The battery system of different types of battery electric machines (BEMs) machines may have different charging needs. The battery system may differ in the amount of charge needed to fully charge the battery system, the rate at which the battery system can be charged, etc.

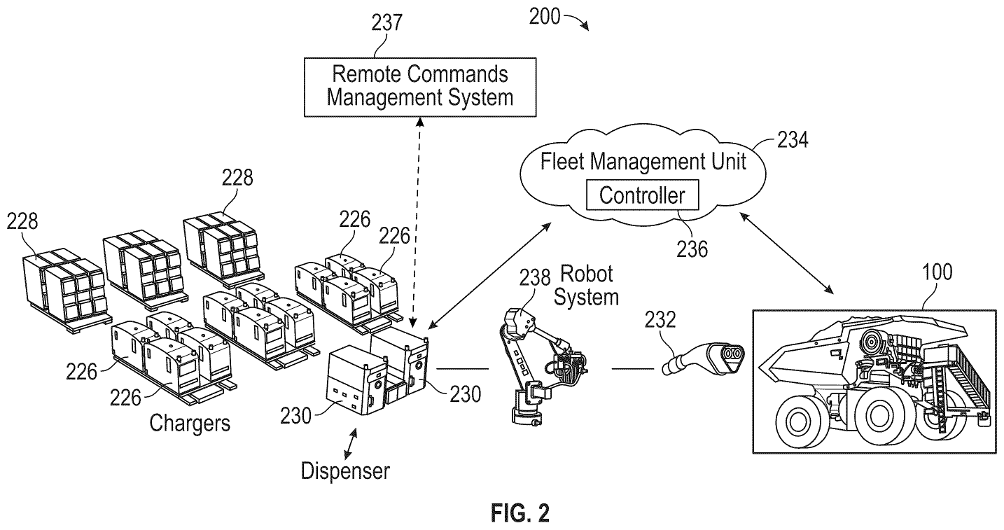

FIG. 2 is a diagram of an example of a charging system 200 for a BEM 100. The system 200 includes multiple charger devices 226. Each charger device 226 is configured to provide high-capacity charge energy for charging a BEM 100. Each of the charger devices 226 can be coupled to one or more switch devices 228 that connect the charger device to a grid, a generator set device, etc. The charging system 200 also includes one or more charge dispenser devices 230. Multiple charger devices 226 are connected to one charge dispenser 230. The example system of FIG. 2 includes two charge dispensers and one to six charger devices 226 are connected to one charge dispenser 230 in the example.

When charging, a charge dispenser 230 is connected to the BEM 100 by a charging cable 232 and plug. The charging cable 232 may be air-cooled or liquid-cooled depending on the capacity of the charging cable 232. A charge dispenser 230 aggregates the charging energy from the charger devices 226 connected to it to provide the aggregated charging energy to the BEM 100 through the charging cable 232. This makes the charging system 200 modular and charging energy from one to six charger devices 226 can be aggregated in the example system of FIG. 2. In some examples, more than six charger devices 226 can be connected to one charge dispenser 230 and the charge from more than six charger devices can be aggregated by the charge dispenser 230.

The BEMs 100 being charged may be automated and may operate without a human operator. Operation of the BEMs may be through a fleet management unit 234. The fleet management unit 234 may be implemented through one or more servers located at the remote site, or through one or more servers that are cloud-based. The fleet management unit 234 manages the displacements of the automated BEMs at the job site. The fleet management unit 234 may include a fleet controller 236 to communicate with the BEMs 100 and charge dispenser 230 wirelessly (e.g., wireless WiFi). The fleet management unit 234 sends specific instructions to the BEMs to move them on specific lanes across the job site. When the fleet management unit 234 determines that a BEM needs charging, the fleet management unit 234 may match a BEM to a charge dispenser 230 based on the charge dispenser's location, availability, and capacity. The charging system 200 may include a robotic connector system 238. The robotic connector system 238 connects and disconnects the charging cable 232 from the receptacle of the BEM 100 in response to commands.

The fleet management unit 234 informs the charge dispenser 230 of the arrival of a BEM 100. When the BEM 100 is ready to be charged, the charge dispenser 230 requests the robotic connector system 238 to connect the charging cable 232 to the BEM 100. Upon connection, the charge dispenser 230 will automatically start a charging session. On completion, the charge dispenser 230 will request the robotic connector system 238 to disconnect the cable 232 and move back to stow position. The charge dispenser 230 may then inform the fleet management unit 234 that the BEM 100 can leave. All these operations can be executed without the help of a human operator on site.

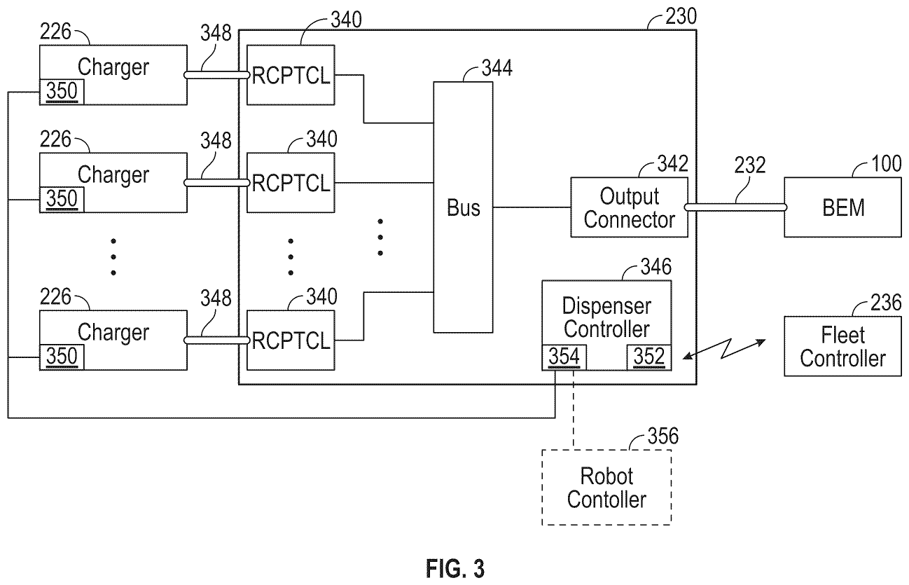

FIG. 3 is a block diagram of an example of portions of a charge dispenser 230. The charge dispenser 230 includes multiple charger input receptacles 340 to receive electrical energy from multiple charger devices 226. Each of the charger devices 226 can provide energy to charge a BEM 100. The charger devices can include power converters to produce the charge energy. The charger devices 226 are connected to the charger input receptacles 340 by charger cables 348. The charge dispenser 230 may send commands to the charger devices 226 to set the output of the power converters to a voltage and current appropriate for the type of BEM 100 being charged. The charge dispenser 230 includes a cable output connector 342 to connect to a charging cable 232 that is connectable to the BEM 100. The charge dispenser 230 can include a dispenser bus 344 that provides accumulated charger energy to the cable output connector 342.

The charge dispenser 230 also includes a dispenser controller 346 and the charger devices 226 each include a charger controller 350. A controller includes processing circuitry that includes one or more processors (e.g., microprocessors, digital signal processors (DSP), application specific integrated circuits (ASICs), a programmable gate arrays (PGAs), or equivalent discrete or integrated logic circuitry. A controller can include memory to store instructions performable by the processing circuitry. The instructions may be software or firmware instructions and the instructions configure the processing circuitry to perform the functions described for the processing circuitry.

The dispenser controller 346 includes a wireless communication port 352 to communicate information wirelessly with the fleet management unit 234 using a wireless communication network (e.g., using a WiFi network). The dispenser controller 346 includes another communication port 354 to communicate information with the charger controllers 350 of the charger devices 226. The dispenser controller 346 and the charger controllers 350 may communicate using another communication network such as an Ethernet network.

The charging system 200 can include a remote commands management system 237 to communicate commands wirelessly with the dispenser controller 346. The communication link with the remote commands management system 237 allows for remote control of the charge dispenser 230. A user may send commands remotely to the charge dispenser 230 through the remote commands management system 237. A user may access the remote commands management system 237 through the Internet by accessing a website. The devices for a job site may be displayed on the website. The user may select a charge dispenser 233, and send commands to start, stop, etc. The dispenser controller 346 accounts for conditions necessary to execute the command (e.g., cable is connected, charging request received, etc.). Given proper validations of the conditions for charging, the dispenser controller 346 can then execute received commands. This allows the user to control the charging system 200 remotely without having to physically go to the location of the system, which may be a large mining site or underground mining site.

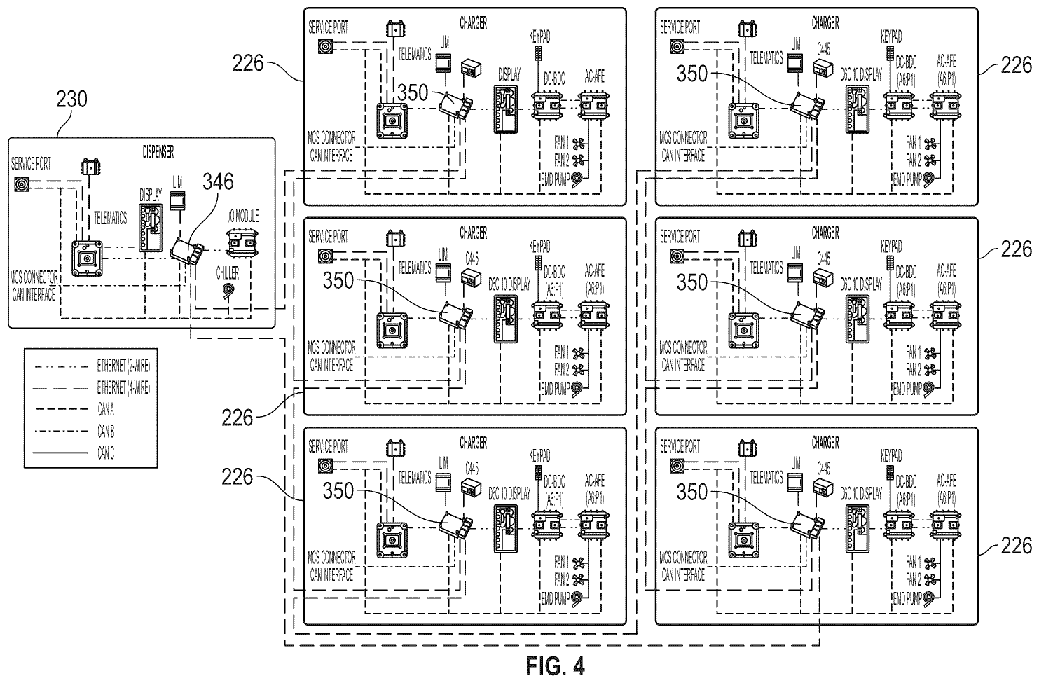

FIG. 4 is a diagram of an example of communication networks for the charger devices 226 and charge dispenser 230 of a charging system 200. The dispenser controller 346 communicates with the charger controllers 350 using a 4-wire Ethernet network. The charger devices 226 and the charge dispenser 230 may include interior sub-networks, such as a 2-wire Ethernet network (e.g., multi-drop network) and one or more controller area networks (CANs). The interior sub-networks are for communication among devices within the charger devices 226 and within the charge dispenser 230. Power allocation and distribution may be managed through messaging using the communication networks.

Returning to FIG. 3, the dispenser controller 346 controls the charging of the BEM 100. The dispenser controller 346 receives an indication (e.g., a charge message or charge command) from the fleet controller 236 of the fleet management unit 234 to start a charging session with the BEM 100. In response, the dispenser controller 346 determines if the BEM 100 is connected for charging. The dispenser controller 346 receives charging information from the BEM 100. The charging information may be different for different types of BEMs. The BEM 100 may include a charge interface controller (CIC) that sends the charging information to the dispenser controller 346. The charging information may include one or more of power, current, or voltage required for the charging of the machine. The charging information may include a state of charge (SOC) of the battery system 120 of the BEM 100.

The dispenser controller 346 uses the charging information to send one or more activation messages to the charger controllers 350 to activate or bring onboard multiple charger devices 226. The dispenser controller 346 may activate or bring onboard all the charger devices 226 for the charging session or activate a multiple number of chargers less than all the charger devices 226. The charge dispenser 230 receives the charging energy from the activated or onboard charger devices 226 and delivers the charging energy to the BEM 100 via the charging cable 232 during the charging session. At any time during the charging session, the dispenser controller 346 may change operation of the charger devices 226. For instance, the dispenser controller 346 may reduce the number of activated charger devices 226, increase the number of activated charger devices 226, or replace a charger device 226 during a charging session. Also, the dispenser controller 346 may adjust the charging energy output of one or more of the activated charger devices 226 during the charging session.

There may be several reasons for the dispenser controller 346 to change or adjust the activation of the charger devices 226 during a charging session. The change or adjustment of the charger devices may be in response to a scheduled change in the charging profile during a charging session. For example, the charging profile may include delivering more charge energy at the beginning of the charging session and reducing the charge energy later in the charging session. The dispenser controller 346 changes the charging configuration of the charger devices 226 in response to the change in demand of charging energy.

In another example, the dispenser controller 346 may detect a fault in one or more charger devices 226, and may deactivate the defective charger devices 226 and activate replacement charger devices 226. The dispenser controller 346 may detect a change (e.g., a decrease) in charge capability of one or more charger devices 226 and send one or more activation messages to change (e.g., increase) the number of active charger devices 226 in response.

The dispenser controller 346 may adjust the charging energy output of one or more of the activated charger devices 226 during the charging session to balance the load among the onboard charging devices 226. Balancing the load during a charging session may be useful to extend the operating life of the charger devices 226.

The dispenser controller 346 may adjust the charging energy output of one or more of the activated charger devices 226 during the charging session in response to temperature information. The dispenser controller 346 may receive temperature information regarding the charging cable 232 (e.g., from one or more temperature sensors monitoring temperature of the charging cable 232). If the temperature increases above a predetermined threshold the dispenser controller may adjust the charging energy output of the charger devices 226 to reduce charging energy in the charging cable 232 or deactivate a charger device 226 to reduce charging energy in the cable. The dispenser controller 346 may also change operation of a cable cooling system to address the increase in cable temperature.

The dispenser controller 346 may adjust the charging energy output of one or more of the activated charger devices 226 during the charging session based on the power derating of the system. For instance, the dispenser controller 346 may adjust the output of the onboard charger devices 226 when power output of the charge dispenser 230 nears a maximum power rating of the charge dispenser 230. The dispenser controller 346 may adjust the output of the onboard charger devices 226 when the output of the charge dispenser 230 nears a maximum power rating of the BEM 100. The dispenser controller 346 may receive an alert of reaching the power limit of the BEM 100 from the CIC of the BEM 100. The dispenser controller 346 uses the power derating information of the charge dispenser 230 or the BEM 100 to automatically adjust power output in real-time. The power derating values for the BEM 100 may increase or decrease at any time. The power derating of the charge dispenser 230 may be a set value unless changed by a user on site or through the fleet management unit 234.

The dispenser controller 346 may also adjust the charging energy output of one or more of the activated charger devices 226 during the charging session in response to external commands (e.g., commands from the fleet management unit 234) based on conditions of the job site. The external commands may be received wirelessly over-the-air to instruct the charge dispenser 230 to limit power output.

As explained previously herein regarding FIG. 2, the charging system 200 can include a robotic connector system 238 to connect and disconnect the charging cable 232 to a charging receptacle of the BEM 100. The robotic connector system 238 includes a robotic controller 356. To start the charging session in response to the indication from the fleet controller 236 to do so, the dispenser controller 346 sends a connect message to the robot controller 356 and the robotic connector system 238 changes from a storage position to connect the charging cable to the BEM 100. The dispenser controller 346 may automatically detect connection of the charging cable 232. For instance, connection of the charging cable 232 to the BEM 100 may cause a connection signal (e.g., sent from the BEM 100) to be detected by the dispenser controller 346. The dispenser controller 346 may proceed to the next step of the charging session (e.g., receiving charge information from the CIC of the BEM 100 in response to detecting that the charging cable 232 is connected.

Before starting the charging session, the dispenser controller 346 may perform a cable check sequence prior to entering the charging session to determine if there are any faults in the charging cable connection between the charge dispenser device 230 and the BEM 100.

When charging of the BEM 100 is complete, the dispenser controller may detect the charge complete condition as the SOC of the BEM 100, or receive an indication of charging complete from the CIC of the BEM 100. The dispenser controller 346 sends an indication to fleet controller 236 that charging is complete. The fleet controller 236 may then schedule a new charging session that the dispenser controller 346 can perform using a different configuration of charger devices 226 depending on the charging requirements of the new BEM 100

If the charging system 200 uses a robotic connector system 238 to connect the charging cable 232, the dispenser controller 346 may send a disconnect message to the robot controller 356 to disconnect the charging cable from the charging receptacle of the BEM 100 when the dispenser controller 346 determines that charging is complete. The dispenser controller 346 may detect that the charging cable 232 is disconnected when the connection signal is no longer detected. The dispenser controller 346 may detect that the charging cable 232 is disconnected by receiving an indication from the robot controller 356 that the charging cable 232 is disconnected and the robotic connector system 238 has returned to the storage position. The dispenser controller 346 informs the fleet controller 236 that the charging is complete and the BEM 100 can be moved away from the charge dispenser device 230.

Aggregating the output of multiple charger devices 226 provides higher capacity charging than approaches that use one charger device 226. The aggregating techniques described are modular and the number of chargers that can be brought onboard is flexible to allow charging of different types of BEMs 100.

### Industrial Applicability

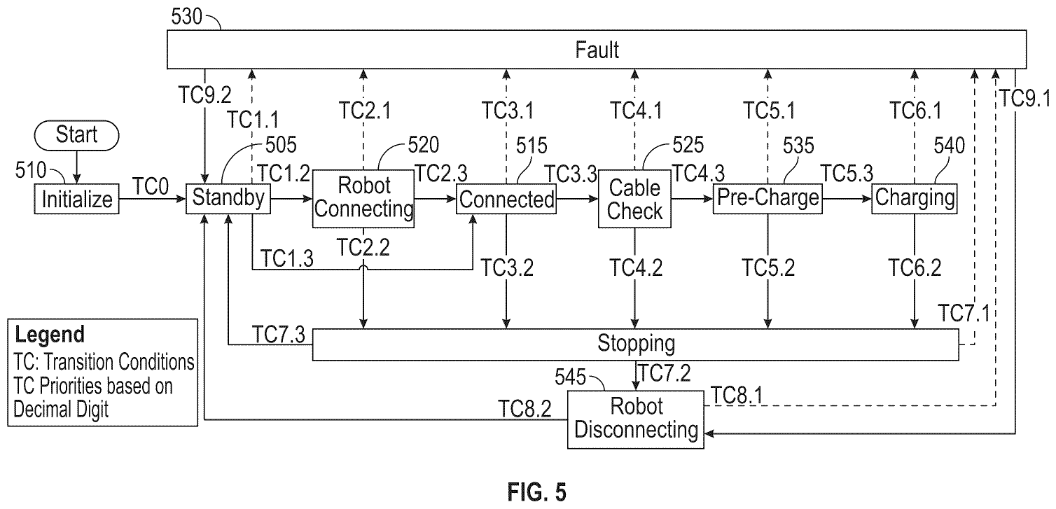

FIG. 5 is a state diagram of an overview of the different states in which the charge dispenser 230 can operate. A charging session may start from the Standby state 505, in which the charge dispenser is waiting for a machine to be ready to charge. The charge dispenser 230 may enter the Standby state upon power up after an Initialize state 510. In the Standby state, the charge dispenser monitors for an indication that a BEM is connected. When a connection is detected, the charge dispenser changes to the Connected state 515.

If the robotic connector system is present, it will move from the Standby state to the Robot Connecting state 520 to monitor for the robotic connection of the charging cable to the machine. From the Connected state, the charge dispenser changes to a Cable Check state 525. In the Cable Check state, the charge dispenser 230 will perform a cable check to ensure there are no faults in one or both of the charging cable connection to the BEM and the cable connections to the charger devices. If there is a fault detected during cable check, the charge dispenser changes to a Fault state 530 in which Fault subroutines may be performed by the dispenser controller 346 to determine the fault and either mitigate the fault or terminate the charging session and send an alert to the fleet management unit related to the fault.

If there is no fault detected, the system will change to the Pre-Charge state 530 to receive charge information and configure the charger devices 226 using the charge information. From the Pre-Charge state, the charge dispenser changes to the Charging state 540 during which the charging of the BEM is performed. When charging is complete, the charge dispenser goes through a disconnecting procedure that may include Robot Disconnecting state 545 before returning to the Standby state. During any of the Initialize, Standby, Connect, Pre-Charge, or Charge states, the charge dispenser checks for faults and may enter the Fault state upon detection of a fault in one or more of a charger device, charger cable connecting charger device, charging cable to the BEM, the charge dispenser itself.

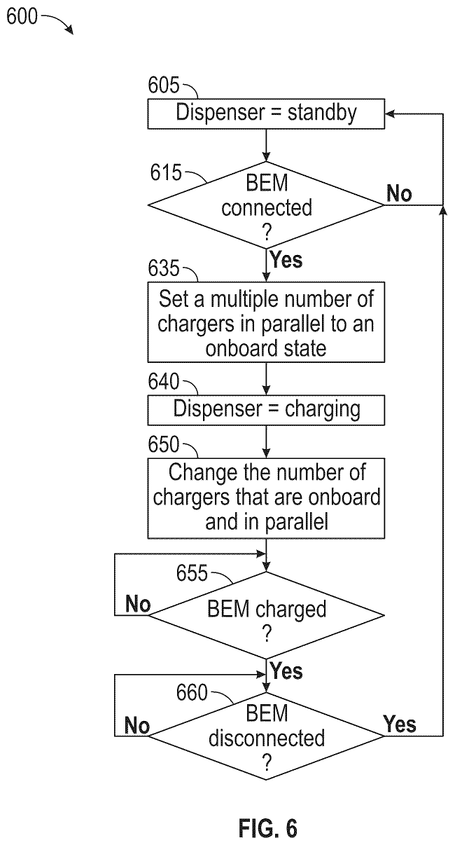

FIG. 6 is a flow diagram of an example of a method 600 of operating a charge dispenser for charging a non-road BEM. The method 600 may be performed using the charge dispenser 230 described previously herein that has multiple charger devices 226 connected to it.

At block 605, the charge dispenser 230 is in a Standby state waiting for information regarding charging of a BEM 100. The fleet management unit 234 may move the BEM 100 to the location of the charge dispenser 230 and may send a command to the charge dispenser 230 to charge the BEM 100. At block 615, the dispenser controller 346 of the charge dispenser 230 waits for a connecting indication from the BEM 100, or BEM charging cable 232, that the BEM 100 is connected for charging and the charge dispenser 230 enters a Connected state. If a robotic connector system 238 is present, the charge dispenser 230 may send a request to the robotic connector system 238 to connect a charging cable 232 to the BEM 100.

At block 635, the dispenser controller 346 configures the charge devices 226. This configuration may be performed during a Pre-Charge state and includes setting two or more charger devices 226 to an onboard state to provide charge energy in parallel to the charge dispenser 230. The dispenser controller 346 may configure the charger devices 226 according to charging information for the BEM 100 received from the fleet management unit 234 or the BEM 100.

At block 640, the charge dispenser 230 enters a Charging state when the conditions for charging are met. The dispenser controller 346 may send updates of charging status to the fleet management unit 234 when in the Charging state. At block 650, the dispenser controller 346 changes the number of charger devices 226 activated in parallel and providing charge during the charging state. The dispenser controller 346 may change number of charger devices 226 activated in response to temperature information regarding the charging cable 232, in response to a fault detected in the charging system 200, or in response to a change in one or both of a change in charge demand and a change in charger capability of one or more of the charger devices 226. Additionally, the dispenser controller 346 may adjust the charging energy output of one or more of the activated charger devices 226 during the charging session in response to a change in charge demand or a change in charger capability of individual charger devices 226.

At block 655, the charge dispenser 230 continues the charging session until charging is complete. The charge complete may be sent from the CIC of the BEM 100, or detected by the dispenser controller 346. When the BEM 100 is charged, the dispenser controller 346 waits for an indication that the BEM is disconnected at block 660. If the robotic connector system 238 is present, the dispenser controller 346 may send a request to the robotic connector system 238 to disconnect the charging cable 232, and the robot controller 356 of the robotic connector system 238 may return a response when the cable is disconnected and stowed. When the dispenser controller 346 receives the response, the dispenser controller 346 may send message to a fleet controller 236 of a fleet management unit 234 that the BEM 100 can be moved away from the charge dispenser.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

The above detailed description is intended to be illustrative, and not restrictive. The scope of the disclosure should, therefore, be determined with references to the appended claims, along with the full scope of equivalents to which such claims are entitled.

What is claimed is:

1. A charge dispenser device to charge battery electric machines (BEMs), the charge dispenser device comprising:
multiple charger input receptacles to receive electrical energy from multiple charger devices, wherein each charger device is configured to provide energy to charge a BEM;
a cable connector configured to connect to a charging cable, wherein the charging cable is connectable to the BEM;
a dispenser controller configured to:
receive an indication from a fleet controller of a fleet management unit to start a charging session with the BEM;
determine when the BEM is connected for charging;
receive charging information for the BEM;
activate a multiple number of charger devices for the charge dispenser to receive charging energy from the charger devices in parallel, and deliver the charging energy to the BEM during the charging session;
change the number of charger devices activated during the charging session; and
send an indication to the fleet controller when charging of the BEM is complete.

2. The charge dispenser device of claim 1, wherein the dispenser controller is configured to:
determine that the BEM is connected to the cable connector by sending an indication to a robot controller of a robotic connector to connect a charging cable to the BEM; and
detect an indication that the BEM is connected.

3. The charge dispenser device of claim 1, wherein the dispenser controller is configured to:
detect that charging of the BEM is complete;
send an indication to a robot controller of a robotic connector to disconnect a charging cable from the BEM in response to detecting the charging is complete;
detect an indication that the charging cable is disconnected; and
send the indication to the fleet controller that the BEM is charged in response to receiving the indication from the robot controller.

4. The charge dispenser device of claim 1, wherein the dispenser controller is configured to:
receive temperature information of a charging cable connected to the cable connector; and
change the number of charger devices activated in parallel during the charging session according to the temperature information.

5. The charge dispenser device of claim 1, wherein the dispenser controller is configured to:
detect a fault in one or more of the charger devices; and
change the number of charger devices activated in parallel during the charging session in response to detecting the fault.

6. The charge dispenser device of claim 1, wherein the dispenser controller is configured to:
activate the multiple number of charger devices according to one or both of charge demand and charging capability of individual chargers; and
change the number of charger devices activated in response to detecting one or both of a change in charge demand and a change in charger capability of one or more of the charger devices.

7. The charge dispenser device of claim 1, wherein the dispenser controller includes:
a communication port to communicate information with charger controllers of the multiple number of charger devices; and
a wireless communication port to communicate information with the fleet controller.

8. A method of operating a charging system for a non-road battery electric machine (BEM), the method comprising:
initiating a charge dispenser device of the charging system to a standby state;
detecting, by the charge dispenser device, a connected state in which the charge dispenser device is connected to the BEM;
entering, by the charge dispenser device, a charging state in which the dispenser activates a multiple number of charger devices in parallel to an onboard state to provide charge at an output of the dispenser;
changing, by the charge dispenser device, the number of charger devices activated in parallel and providing charge during the charging state;
detecting, by the charge dispenser device, that charging of the BEM is complete;
sending an indication to another device to disconnect the BEM from the dispenser in response to detecting the charging is complete; and
returning to the standby state when detecting disconnect of the BEM.

9. The method of claim 8, including:
entering, by the charge dispenser device, a cable check state prior to entering the charging state, wherein the charge dispenser device determines whether there is a fault in a charging cable connection between the charge dispenser device and the BEM in the cable check state.

10. The method of claim 8, including:
determining, by the charge dispenser device, temperature of the charging system; and
changing the number of charger devices activated in parallel during the charging state according to determined temperature.

11. The method of claim 8, including:
detecting, by the charge dispenser device, a fault in one or more of the charger devices of the charging system; and
changing the number of charger devices activated in parallel during the charging state in response to detecting the fault.

12. The method of claim 8, including:
activating, by the charge dispenser device, the number of charger devices according to one or both of charge demand and charging capability of individual charger devices; and
changing the number of charger devices activated in response to detecting one or both of a change in charge demand and a change in charger capability of one or more of the charger devices.

13. The method of claim 8, including:
activating, by the charge dispenser device, the number of charger devices according to one or both of charge demand and charging capability of individual charger devices; and
adjusting charging energy output of one or more of the activated charger devices in the charging state.

14. The method of claim 8, including:
receiving, by the charge dispenser device, an indication to charge a BEM from a fleet controller of a fleet management unit;
sending, by the charge dispenser device, a request to a robotic connector system to connect a charging cable to the BEM;
entering the charging state in response to detecting cable connection to the BEM; and
sending an indication of charging status to the fleet controller when in the charging state.

15. The method of claim 8, including:
detecting, by the charge dispenser device, that charging of the BEM is complete;
sending, by the charge dispenser device, a request to a robotic connector to disconnect a charging cable from the BEM;
receiving a response from the robotic connector that the cable is disconnected; and
sending a message to a fleet controller of a fleet management unit that the BEM can be moved away from the charge dispenser device.

16. A charging control system to charge battery electric machine (BEMs), the system comprising:
a fleet controller of a fleet management unit;
a dispenser controller of a charge dispenser device of the charging system;
a plurality of charger controllers, each charger controller included in a charger device that is connected to the dispenser device and is configured to provide energy to charge a BEM;
a communication network configured to transfer information among the fleet controller, the dispenser controller and the charger controllers; and
wherein the dispenser controller is configured to:
receive a charge message via the communication network from the fleet controller to start a charging session with the BEM; and
send, in response to the charge message, an activation message via the communication network to a multiple number of the plurality of charger controllers to activate a multiple number of charger devices to an onboard state to provide charging energy in parallel to the dispenser.

17. The system of claim 16, wherein the dispenser controller is configured to:
determine state of charge (SOC) of the BEM and determine that the charging session is complete according to the SOC;
receive another charge message from the fleet controller to start another charge session; and
send another activation message to the plurality of charger controllers to change the number of charger devices that are onboard between the charging session and the other charge session.

18. The system of claim 16, wherein the dispenser controller is configured to:
receive information regarding charge energy output of the charger devices from the charger controllers during a charging session; and
send another activation message to the plurality of charger controllers to adjust the charge energy output of one or more of the charger devices during the charging session according to the received information.

19. The system of claim 16, including:
a robot controller included in a robotic connector configured to connect a charging cable between an output of the dispenser and a charging receptacle of the BEM; and
wherein the dispenser controller is configured to:
send a connect message to the robot controller in response to receiving the charge message; and
send the activation message to the charger controllers in response to receiving an indication from the robot controller that the charging cable is connected to the charging receptacle of the BEM.

20. The system of claim 16, including:
a robot controller included in a robotic connector configured to disconnect a charging cable from a charging receptacle of the BEM;
wherein the dispenser controller is configured to:
detect a state of charge (SOC) of the BEM;
send a disconnect message to the robot controller to disconnect the charging cable from the charging receptacle of the BEM according to the SOC;
receive an indication from the robotic connector that the cable is disconnected; and
send a message to the fleet controller that the BEM can be moved away from the dispenser in response to receiving the indication that the charging cable is disconnected.
